(19) United States
(12) Patent Application Publication
(10) Pub. No.: US 2008/0111701 A1
(43) Pub. Date: May 15, 2008

(54) Smoke detector having camera

(75) Inventor: Yuan-Yu Huang, Taipei City (TW)

Correspondence Address: TROXELL LAW OFFICE PLLC, 5205 LEESBURG PIKE, SUITE 1404, FALLS CHURCH, VA, 22041, US

(73) Assignee: HANSDER ENGINEERING CO., LTD., Taipei City (TW)

(21) Appl. No.: 11/723,755

(22) Filed: Mar. 21, 2007

(30) Foreign Application Priority Data
Nov. 9, 2006 (CN) 200620148847.5

(51) Int. Cl. G08B 17/11

(52) U.S. Cl. 340/629

(57) ABSTRACT

A smoke detector simultaneously processes signals from a detector and signals from an image capture unit through using a power frequency carrier device. Thus, an early alarm can be made by the detector. Nevertheless, the detector can be easily installed at any p lace without a complex wiring.

### FIELD OF THE INVENTION

The present invention relates to a smoke detector; more particularly, relates to simultaneously processing signals from a detector and an image capture unit and obtaining an easy installation at any place without a complex wiring.

### DESCRIPTION OF THE RELATED ART

General smoke detectors are used in banks, offices, building, etc., where fires are alarmed by sensing the smokes generated by the fires. Two kinds of detectors are most commonly used: one is an ion detect or and the other one is an optoelectrical detector.

Concerning the ion detector, an action is activated by a smoke locally having a density higher than a certain value for a specific environment, where a change of an ion current caused by the smoke is sensed. Concerning the optoelectrical detector, an action is activated by a change of an illumination received by a light-emitting unit, where th e change is caused by the particles in the smoke having a density higher than a certain value for a specific environment.

No matter what kind of detector it is, the detector must be coordinated with a camera to prevent the environment from fire. Generally, the detector and the camera are two separated devices to be connected with a control panel an d a display screen in a control room, respectively. Hence, signals from the detector and signals from the camera are not processed simultaneously and so a fire alarm for the environment is not early noticed. In addition, if a design of wirings for the detector and the camera is not preserved in advance, the wirings become more complex, not to mention the cost increased at the same time. Hence, the prior arts do not fulfill users' requests on actual use.

### SUMMARY OF THE INVENTION

The main purpose of the present invention is to process signals from the detector and the image capture unit simultaneously for an early notice and to obtain ah easy installation at any place through using a power frequency carrier device without a complex wiring To achieve the above purpose, the present invention is a smoke detector having a camera, comprising a detector comprising a first sensor, a second sensor and a switching circuit unit; an image capture unit; and a power frequency carrier device, where the switching circuit unit, the image capture unit and the power frequency carrier device are connected with a power unit; and the power frequency carrier device connects to an indoor power source through a connection unit. Accordingly, a novel smoke detector having a camera is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is the perspective view showing the first preferred embodiment according to the present

FIG. 2 is the structural view showing the first preferred embodiment;

FIG. 3 is the view showing the state of use of the first preferred embodiment;

FIG. 4 is the view showing the state of use of the second preferred embodiment;

FIG. 5 is the perspective view showing the third preferred embodiment;

FIG. 6 is the structural view showing the third preferred embodiment;

FIG. 7 is the block view showing the power frequency carrier device;

FIG. 8 is the view showing the state of use of the third preferred embodiment; and

FIG. 9 is the view showing the state of use of the fourth preferred embodiment.

### DESCRIPTION OF THE PREFERRED EMBODIMENTS

The following descriptions of the preferred embodiments are provided to understand the features and the structures of the present invention.

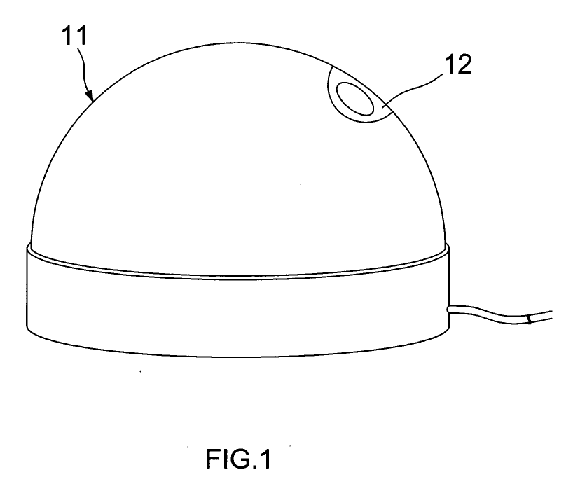

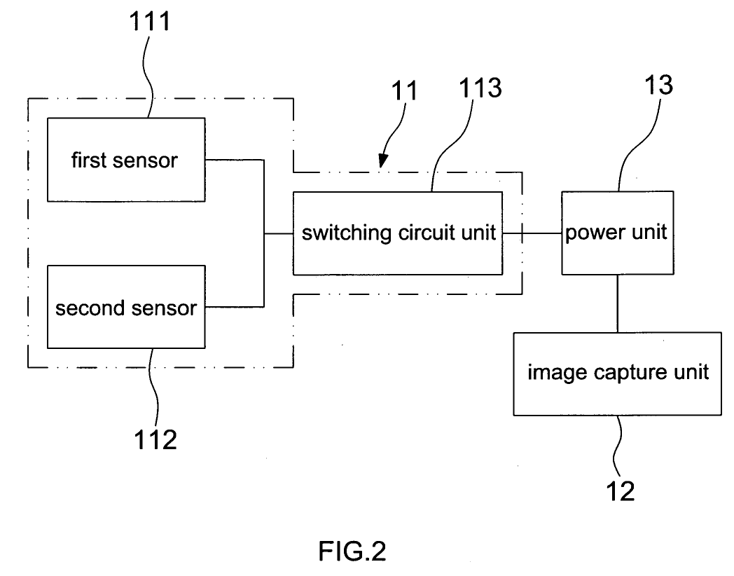

Please refer to FIG. 1 and FIG. 2, which are a perspective view and a structural view showing a first preferred embodiment according to the present invention. As shown in the figures, the present invention is a smoke detector having a camera, comprising a detector [11] and an image capture unit [12], where signals from the detect or [11] and signals from the image capture unit [12] are processed simultaneously to obtain an early notice.

The detector [11] comprises a first sensor [111]; a second sensor [112] corresponding to the first sen so [111]; and a switching circuit unit [113] connecting to the first sensor [111], the second sensor [112] and a power unit [13].

The image capture unit [12] is a camera made of a charge-coupled device (CCD) or a complementary metal-oxide semiconductor (CMOS); and is connected to the power unit [13]. Thus, with the above structure, a novel smoke detector having a camera is obtained.

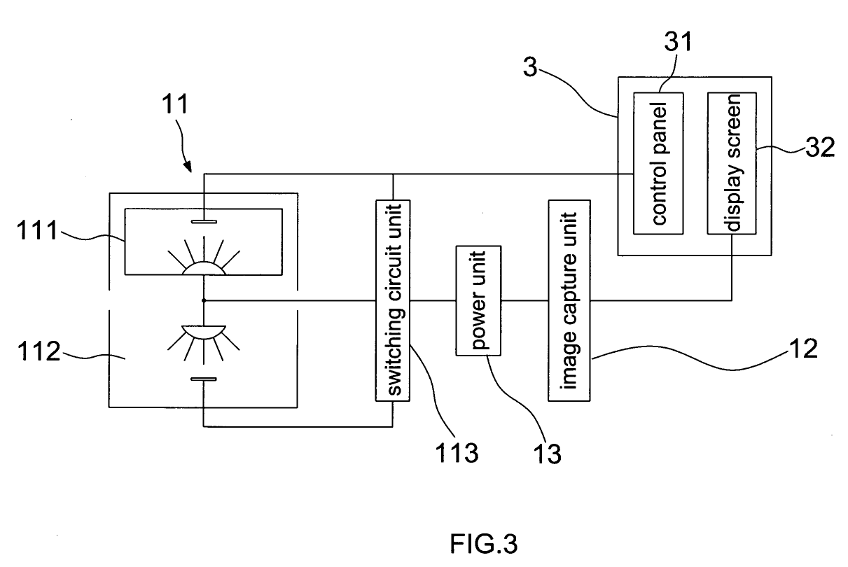

Please refer to FIG. 3, which is a view showing a state of use of the first preferred embodiment. As shown in the figure, when u sing the first preferred embodiment, a first sensor [111] of a detector [11], which is an inner ion chamber generating a first current, and a second sensor [112] of the detector [11], which is an outer ion chamber generating a second ion current, are used to obtain the detector [11] as an ion detector located in a specific environment. An image capture unit [12] is connected with a display screen [32] in a control room [3] so that the image capture unit [12] transfers image of the specific environment to be displayed on the display screen [32]. And a power unit [13] is connected with a switching circuit unit [113] and the image capture unit [12] to supply power to the first sensor [111], the second sensor [112] and the image capture unit [12]. When using the first preferred embodiment, the first sensor [111] and the second sensor [111] have americium-241 (Am-241) inside as s radiation source and a certain volt difference is kept between the first sensor [111] and the second sensor [111]. When there is no smoke in the environment, the ion currents and the volt difference are remained unchanged Once there is a smoke around the second sensor [112], the ion current and the volt of the second sensor [112] are changed. If, then, the volt difference becomes greater than a default value for the volt difference, the switching circuit unit [113] is switched on automatically and an alarm signal is transferred to the control panel [31]. Thus, signals from the detector [11] and signals from the image capture unit [12] are processed simultaneously to obtain an early notice.

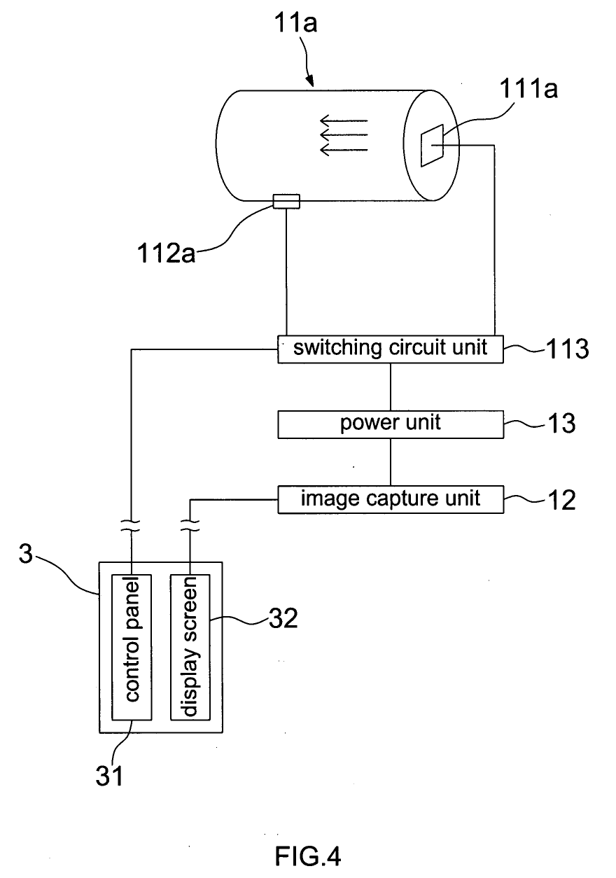

Please refer to FIG. 4, which is a view showing a state of use of a second preferred embodiment. As shown in the figure, in a specific environment, a first sensor [111a] of a detector [11a] is a light-emitting unit and a second sensor [112a] of the detector [11a] is a light-receiving unit so that the detector [11a] is made as an optoelectrical detector. An image capture unit [12] is connected with a display screen [32] in the control room [3] so that the image capture unit [12] transfers image of the specific environment to be displayed on the display screen [32]. And a power unit [13] is connected with a switching circuit unit [113] and the image capture unit [12] to supply power to the first sensor [111a], the second sensor [112a] and the image capture unit [12]. When using the second preferred embodiment, the first sensor [111a] emits a light beam in a certain direction along a light axis to be received by the second sensor [112a]. When there is no smoke in the specific environment an illumination generated by the first sensor [111a] and the illumination received by the second sensor [112a] have the same strength. Once there is a smoke having a density higher than a certain limit in the environment, the light beam a long the light axis is scattered so that the illumination received by the second sensor [112a] is weakened. When the illumination received by the second sensor [112a] is weakened to a certain degree, the switching circuit unit [113] is switched on automatically and an alarm signal is transferred to the control panel [31]. Thus, signals from the detector [11a] and the image capture unit [12] are processed simultaneously to obtain an early notice.

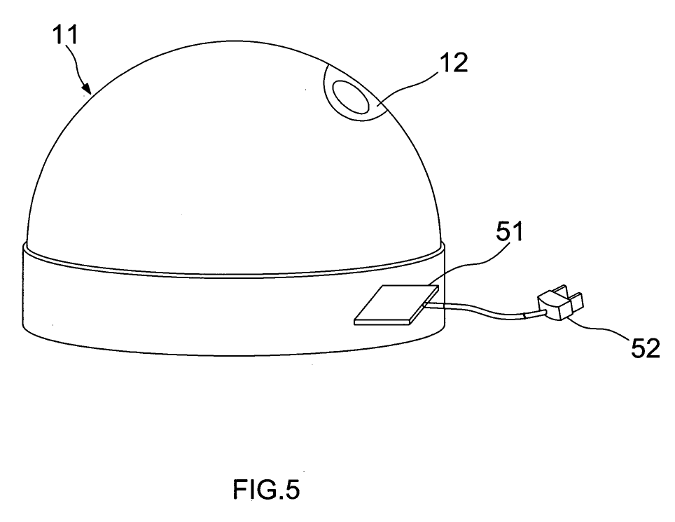

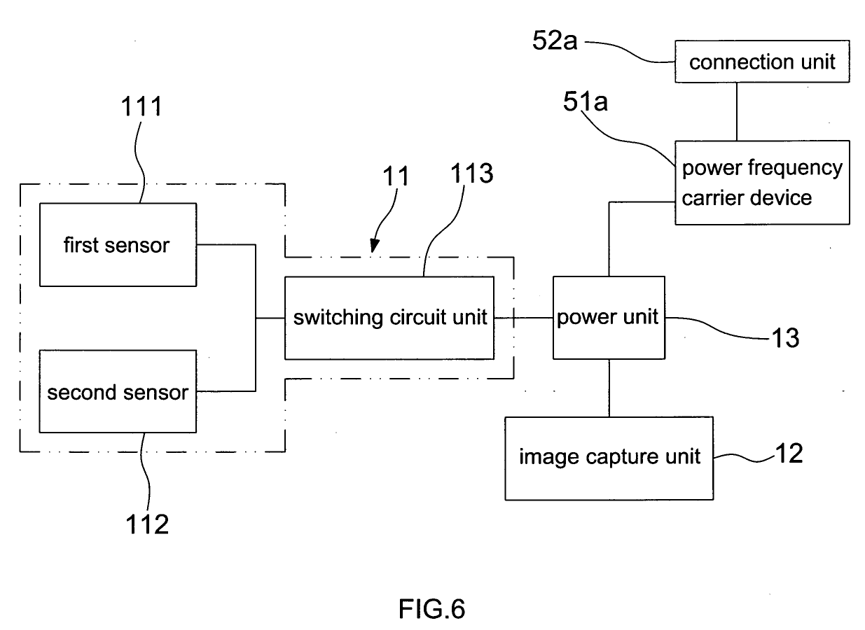

Please refer to FIG. 5 and FIG. 6, which are a perspective view and a structural view showing a third preferred embodiment. As shown in the figures, the third embodiment comprises a detect or [11], an image capture unit [12] and a first power frequency carrier device [51a], where signals from the detector [11] and signals from the image capture unit [12] are processed simultaneously to obtain an early notice; and an easy installation at any place is obtained through using the first power frequency carrier device [51a] without a complex wiring.

The detector [11] comprises a first sensor [111 ]; a second sensor [112] corresponding to the first sensor [111]; and a switching circuit unit [113] connecting to the first sensor, the second sensor and a power unit [13].

The image capture unit [12] is a camera connected to the power unit [13].

The first power frequency carrier device [51a] is connected with the power unit [13]; and has a first connection unit [52a] to connect to an indoor power source [6]. Thus, with the above structure, a novel smoke detector having a camera is obtained.

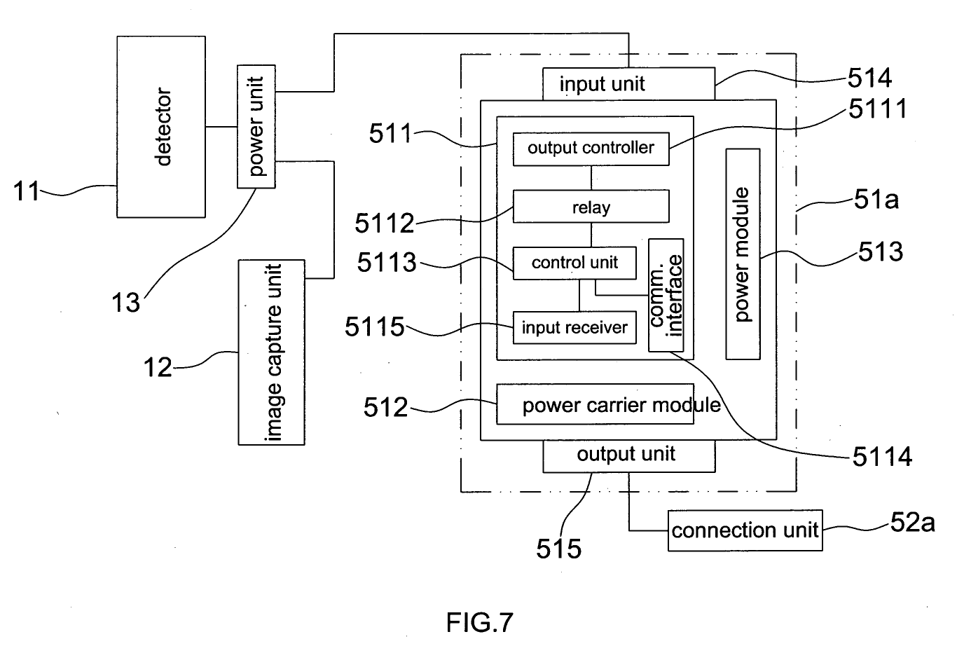

Please refer to FIG. 7, which is a block view showing the power frequency carrier device. As shown in the figure, a first power frequency carrier device [51a] comprises a single-chip control module [511]; a power carrier module [512] having a transmission rate of 1200 BPS (bit per second); an electricity module [513] providing required powers for the single-chip control module [511] and the power carrier module [512]; an input unit [514] connecting to a power u nit [13]; and an output unit [51 5] connecting to a first connection unit [52a], where the single-chip control module [511] comprises an output controller [5111], a relay [5112], a control unit [5113], a communication interface [5114] and an input receiver [5115].

Therein, the control unit [5113] of the first power frequency carrier device [51a] is a 8051 single-chip as a processing unit with a good inner structure, whose working frequency is up to 16 MHz with a 4 k size of electrically programmable and erasable ROM (Read Only Memory) together with eight input pins and eight output pins. The relay [5112] is located at the output pins of the 8051 single-chip to quarantine the circuit for securing and ensuring the operation of the single-chip control module [511]. The 8051 single-chip contains the full-duplex communication interface [5114] in side . The communication interface [5114] is an RS232 interface to simultaneously transfer and receive data to and from outside. The operational signals in the 8051 single-chip are on a TTL (transistor-transistor-logic) level (0 volt is set as logic 0 and +5 volts is set as logic 1) and the communication interface [5114] is a serial communication interface to transfer and receive data in a form of bit series.

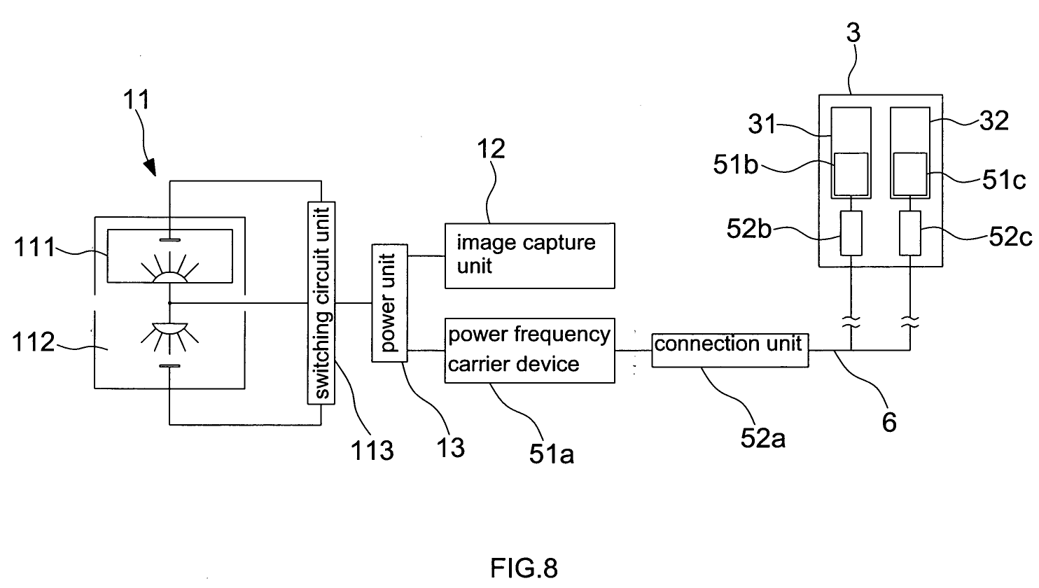

Please further refer to FIG. 8, which is a view showing a state of use of the third preferred embodiment. As shown in the figure, a detector [11] as an ion detector coordinated with a first power frequency carrier device [51a] is located in a specific environment, where a first connection unit [52a] is connected with the first power frequency carrier device [51a] and an indoor power source [6]. A control panel [31] having a second power frequency carrier device [51b] is set in a control room [3], where a second connection unit [52b] is connected with the second power frequency carrier device [51b] and an indoor power source [6]. And a display screen [32] having a third power frequency carrier device [51c] is set in the control room [3], where a third connection unit [52c] is connected with the third power frequency carrier device [51c] and an indoor power source [6]. Thus, the present invention is installed, where real time image of the environment is displayed on the display screen [32].

Once there is a smoke around a second sensor [112] in the environment an ion current and a volt of the second sensor [112] are changed. If, then, the volt difference between a first sensor [111] and the second sensor [112] becomes greater than a default value for the volt difference, a switching circuit unit [113] is switched on automatically and an alarm signal is transferred to the control panel [31] from the detector [11]. Therein, the detector [11] and an image capture unit [12] are supplied with power by a power unit [13]; and signals from the detector [11] and signals from the image capture unit [12] are transferred from the first power frequency carrier device [51a] through the first connection unit [52a] along the indoor power source [6] to the second connection unit [52b] of the control panel [31] and the fourth connection unit [52b] of the display screen [32], respectively. Thus, signals from the detector [11] and signals from the image capture unit [12] are processed simultaneously to obtain an early notice; and an easy installation at any place is obtained through using a power frequency carrier device without a complex wiring.

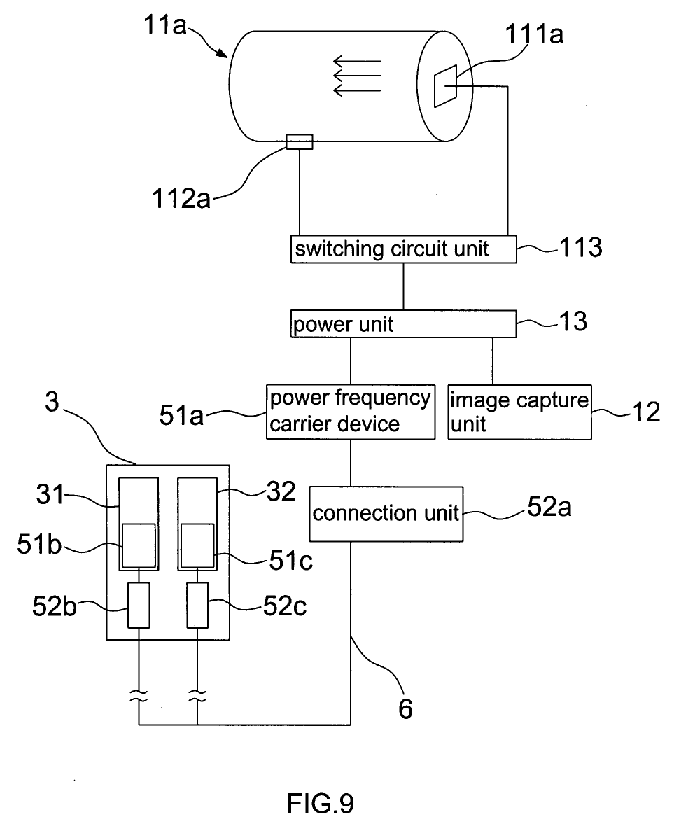

Please further refer to FIG. 9, which is a view showing a state of use of a fourth preferred embodiment. As shown in the figure, a detector [11a] as a light-emitting unit coordinated having a first power frequency carrier device [51a] is located in a specific environment, where a first connection unit [52a] is connected with the first power frequency carrier device [51a] and an indoor power source [6]. A control panel [31] having a second power frequency carrier device [5 1b] i s set in a control room [3], where a second connection unit [52b] is connected with the second power frequency carrier device [51b] and an indoor power source [6]. And a display screen [32] having a third power frequency carrier device [51c] is set in the control room [3], where a third connection unit [52c] is connected with the third power frequency carrier device [51c] and an in door power source [6]. Thus, the present invention is installed, where real time image of the specific environment is displayed on the display screen [32].

Once a smoke having a density higher than a certain limit a rises in the environment, the light beam a long the light axis is scattered so that an illumination received by a second sensor [112a], which is emitted from a first sensor [111a], is weakened. When the illumination received by the second sensor [112a] is weakened to a certain degree, the switching circuit unit [113] is switched on automatically and an alarm signal is transferred to the control panel [31] from the detector [11a]. Therein, the detector [11a] and an image capture unit [12] are supplied with power by a power unit [1 3]; and signals from the detector [11a] and signals from the image capture unit [12 are transferred from the first power frequency carrier device [51a] through the first connection unit [52a] a long the indoor power source [6] to the second connection unit [52b] of the control panel [31] and the third connection unit [52c] of the display screen [32], respectively. Thus, signals from the detector [11a] and signals from the image capture unit [12] are processed simultaneously to obtain an early notice; and an easy installation at any place is obtained through using power frequency carrier device without a complex wiring.

To sum up, the present invention is a smoke detector having a camera, where signals from a detector and signals from an image capture unit are processed simultaneously to obtain an early notice; and an easy installation at any place is obtain ed through using a power frequency carrier device without a complex wiring.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A smoke detector having a camera, comprising:
a detector, said detector comprising
a first sensor;
a second sensor, said second sensor corresponding to said first sensor; and
a switching circuit unit, said switching circuit unit connecting to said first sensor, said second sensor and a power unit; and
an image capture unit, said image capture unit connecting to said power unit.

2. The detector according to claim 1
wherein said first sensor is an inner ion chamber generating a first ion current.

3. The detector according to claim 1,
wherein said first sensor is a light-emitting unit.

4. The detector according to claim 1,
wherein said second sensor is an outer ion chamber generating a second ion current

5. The detector according to claim 1,
wherein said second sensor is a light-receiving unit.

6. The detector according to claim 1
wherein said image capture unit is selected from a group con si sting of a charge-coupled device (CCD) and a complementary metal-oxide semiconductor (CMOS).

7. The detector according to claim 1,
wherein said image capture unit is connected with a display screen.

8. A smoke detector having a camera, comprising:
a detector, said detector comprising
a first sensor;
a second sensor, said second sensor corresponding to said first sensor; and
a switching circuit unit, said switching circuit unit connecting to said first sensor, said second sensor and a power unit;
an image capture unit, said image capture unit connecting to said power unit; and
a power frequency carrier device, said power frequency carrier device connecting to said power unit, said power frequency carrier device connecting to an indoor power source through a connection unit.

9. The detector according to claim 8,
wherein said first sensor is an inner ion chamber generating a first ion

10. The detector according to claim 8,
wherein said first sensor is a light-emitting unit.

11. The detector according to claim 8,
wherein said second sensor is an outer ion chamber generating a second ion current

12. The detector according to claim 8,
wherein said second sensor is a light-receiving unit.

13. The detector according to claim 8,
wherein said image capture unit is selected from a group consisting of a CCD and a CMOS.

14. The detector according to claim 8,
wherein said image capture unit is connected with a display screen.

15. The detector according to claim 8,
wherein said power frequency carrier device comprises a single-chip control unit, a power carrier module, an electricity module, an output module and an input module.

16. The detector according to claim 15,
wherein said power carrier module has a transmittal baud rate of 1200 BPS.

17. The detector according to claim 15,
wherein said single-chip control unit comprises an input unit, an output controller, a control unit, a communication interface and a relay

18. The detector according to claim 17,
wherein said control unit is a 8051 single-chip.

19. The detector according to claim 17,
wherein said control unit has a working frequency of 16 MHz.

20. The detector according to claim 17,
wherein said communication interface is an RS232 interface.
